(19) United States
(12) Patent Application Publication
(10) Pub. No.: US 2013/0332629 A1
(43) Pub. Date: Dec. 12, 2013

(54) CONFIGURATION CONTROLLER AND CONFIGURATION CONTROL METHOD

(71) Applicant: FUJITSU LIMITED, Kawasaki-shi (JP)

(72) Inventors: Katsuyuki OKABE, Fukuoka (JP); Koichi KINOSHITA, Fukuoka (JP); Kenichi OHYAMA, Fukuoka (JP); Haruhisa FUKANO, Munakata (JP); Yuji SHIMADA, Kawasaki (JP)

(73) Assignee: FUJITSU LIMITED, Kawasaki-shi (JP)

(21) Appl. No.: 13/875,700

(22) Filed: May 2, 2013

(30) Foreign Application Priority Data
Jun. 11, 2012 (JP) 2012-132064

(51) Int. Cl. G06F 13/10

(52) U.S. Cl. CPC G06F 13/102
USPC 710/8

(57) ABSTRACT

A configuration controller configured to control configuration of a partially configurable programmable device, includes a determination unit configured to determine whether or not circuit data to be arranged in any one of a plurality of areas in the programmable device matches desired circuit data for which a desired arrangement target area is specified, before the circuit data to be arranged is written into the programmable device, and a data controller configured to control whether or not the circuit data to be arranged is to be written into the programmable device, in accordance with the determination result of the determination unit.

### CROSS-REFERENCE TO RELATED APPLICATION

This application is based upon and claims the benefit of priority of the prior Japanese Patent Application No. 2012-132064, filed on Jun. 11, 2012, the entire contents of which are incorporated herein by reference.

### FIELD

The embodiment discussed herein is related to a configuration controller and a configuration control method.

### BACKGROUND

Recently, many types of programmable devices typified by a field programmable gate array (FPGA) have been provided. To operate an FPGA in which a logic circuit may be freely designed, an initialization operation called “configuration” in which circuit data is written into the FPGA is performed on the FPGA.

There is a technique called “partial configuration”. In partial configuration, the writable area of an FPGA (hereinafter, may be referred to as an “FPGA area”) into which circuit data is written is divided into multiple areas, and each of circuits, which are different from each other, is incorporated into a corresponding one of the multiple areas. Each of the areas obtained through the division may be called a “port”.

Before partial configuration became widespread, the entire FPGA into which multiple types of circuits were incorporated had to be configured even when only one circuit was changed. Therefore, when a circuit was to be changed, all of the line connections in the FPGA were temporarily cut, causing the FPGA to enter the non-operation state.

In contrast, partial configuration makes it possible, when a circuit in any port is to be changed, to change the circuit without affecting the other ports. That is, when a circuit in any port is to be changed, partial configuration enables only that port to be configured. Therefore, when partial configuration is used, only a target port in an FPGA in which a circuit is to be changed enters the non-operation state, whereas the other ports remain in the operation state.

In partial configuration, pieces of circuit data corresponding to respective circuit types are prepared for each of multiple ports. These pieces of circuit data are stored in advance in a ROM such as a flash memory which is mounted on a substrate on which an FPGA is also mounted. Therefore, circuit data may be called “ROM data”.

Heretofore, to prepare for damage of ROM data due to, for example, an error which occurs when the data is stored into a ROM, it has been common to perform a data check through, for example, a cyclic redundancy check (CRC) before and after performing configuration so as to check whether or not ROM data is normal.

Japanese Laid-open Patent Publication No. 2008-236488 is an example of the related art.

### SUMMARY

According to an aspect of the invention, a configuration controller configured to control configuration of a partially configurable programmable device, the configuration controller includes: a determination unit configured to determine whether or not circuit data to be arranged in any one of a plurality of areas in the programmable device matches desired circuit data for which a desired arrangement target area is specified, before the circuit data to be arranged is written into the programmable device; and a data controller configured to control whether or not the circuit data to be arranged is to be written into the programmable device, in accordance with the determination result of the determination unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary FPGA area;

FIG. 2 is a diagram illustrating an exemplary ROM data area map;

FIG. 3 is a diagram illustrating an exemplary configuration structure;

FIG. 4 is a diagram illustrating exemplary storage of ROM data;

FIG. 5 is a diagram illustrating exemplary arrangement of ROM data;

FIG. 6 is a block diagram illustrating an exemplary structure of a configuration controller according to an embodiment;

FIG. 7 is a diagram illustrating exemplary ROM data management information according to an embodiment;

FIG. 8 is a diagram illustrating exemplary FPGA area division according to an embodiment;

FIG. 9 is a functional block diagram illustrating an exemplary FPGA according to an embodiment;

FIG. 10 is a block diagram illustrating an exemplary structure of a data stream controller according to an embodiment; and

FIGS. 11A to 11D are a diagram for describing an operation of a configuration controller according to an embodiment.

### DESCRIPTION OF EMBODIMENT

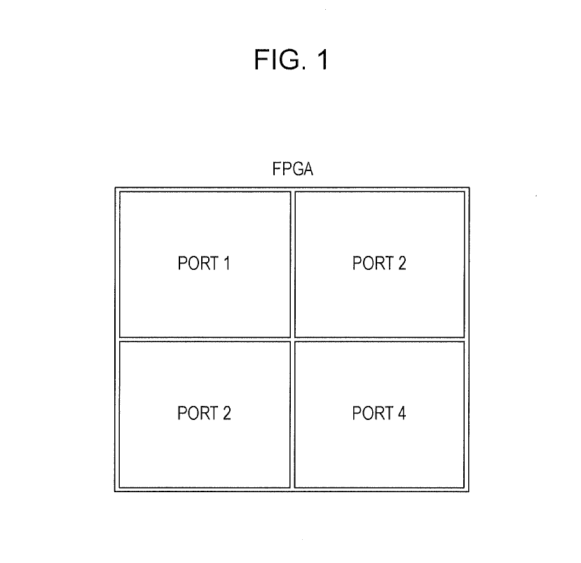

FIG. 1 illustrates an exemplary FPGA area in partial configuration. FIG. 1 illustrates the case in which the FPGA area is divided into four areas of ports 1 to 4. In the FPGA illustrated in FIG. 1, partial configuration is performed on each of the ports 1 to 4.

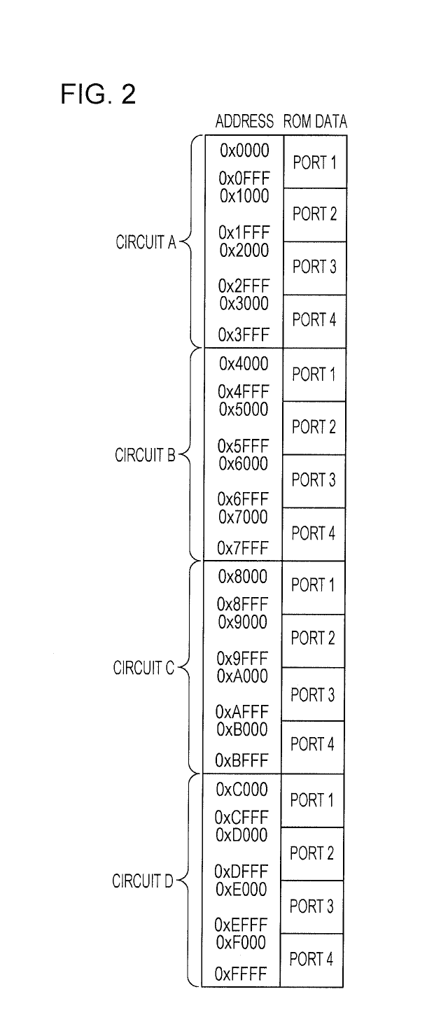

FIG. 2 illustrates an exemplary ROM data area map for partial configuration. When different circuits, that is, circuits A to D, are prepared for each of the four ports of the ports 1 to 4, as illustrated in FIG. 2, each of 16 pieces of ROM data is stored in a ROM in such a manner as to be associated with a ROM address. That is, to configure the four ports of the ports 1 to 4 by using the circuit A, four pieces of ROM data for the circuit A which correspond to the respective ports are prepared. The same is true for the circuits B to D.

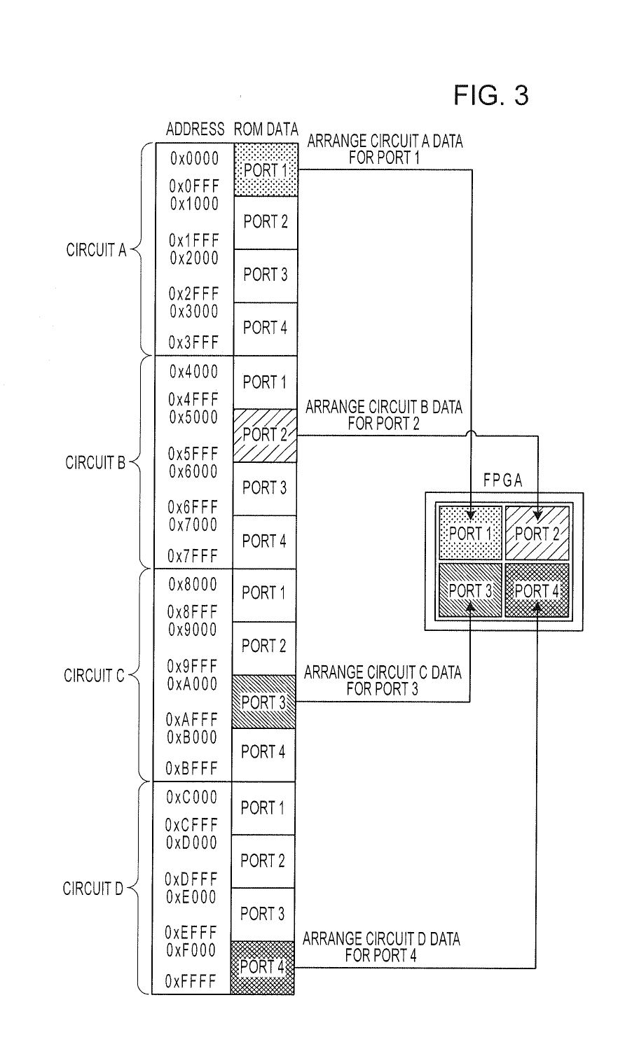

FIG. 3 illustrates an exemplary configuration structure. FIG. 3 illustrates the case in which the ports 1, 2, 3, and 4 are configured using circuit A data, circuit B data, circuit C data, and circuit D data, respectively.

A user using an FPGA (hereinafter, abbreviated as a “user”) specifies configuration target data for each of the ports by using a ROM address on the basis of functions to be achieved. Thus, a user gives an instruction to configure any port. In accordance with the instruction, ROM data stored at the specified address is arranged in a corresponding one of the ports in the FPGA. Each piece of ROM data for a corresponding one of the ports has unique location information. The unique location information is, for example, the number of an arrangement target port or an address indicating an arrangement target area. Therefore, the circuit A data for the port 1 is arranged to configure the port 1 in the FPGA, and the circuit B data for the port 2 is arranged to configure the port 2. Similarly, the circuit C data for the port 3 is arranged to configure the port 3 in the FPGA, and the circuit D data for the port 4 is arranged to configure the port 4.

Circuit data is stored in a ROM through an operation performed by a user. Therefore, when a user is to store circuit data for a certain port in a ROM, the user may write circuit data for another port at an address at which the user wants to store the circuit data for the certain port, by mistake. That is, the correspondence between circuit data for each of the ports and a ROM address may be different from what a user intends.

The above-described data check, for example, through a CRC is performed to check whether or not ROM data is damaged. Therefore, in this data check, data written at a wrong address is not determined to be error data, if the data itself is not damaged.

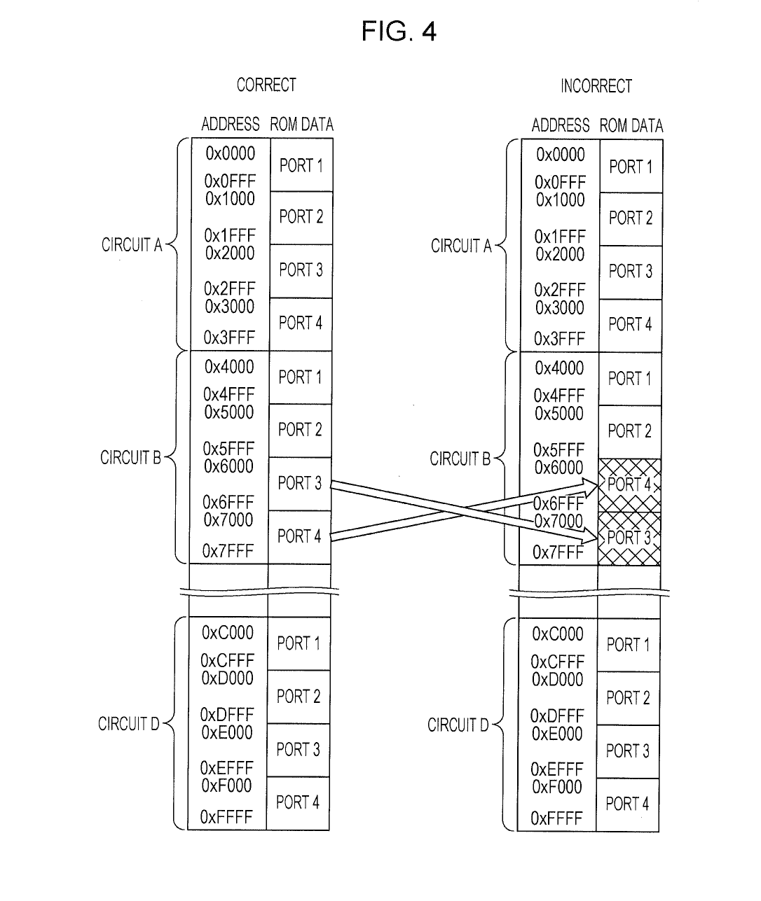

FIG. 4 illustrates exemplary storage of ROM data. In this example, the correct storage state in a ROM is assumed as a state in which the circuit B data for the port 3 is written at the addresses 0x6000 to 0x6FFF and in which the circuit B data for the port 4 is written at the addresses 0x7000 to 0x7FFF (see the left part of FIG. 4). In contrast, a user has written the circuit B data for the port 4 at the addresses 0x6000 to 0x6FFF by mistake, and has written the circuit B data for the port 3 at addresses 0x7000 to 0x7FFF by mistake (see the right part of FIG. 4).

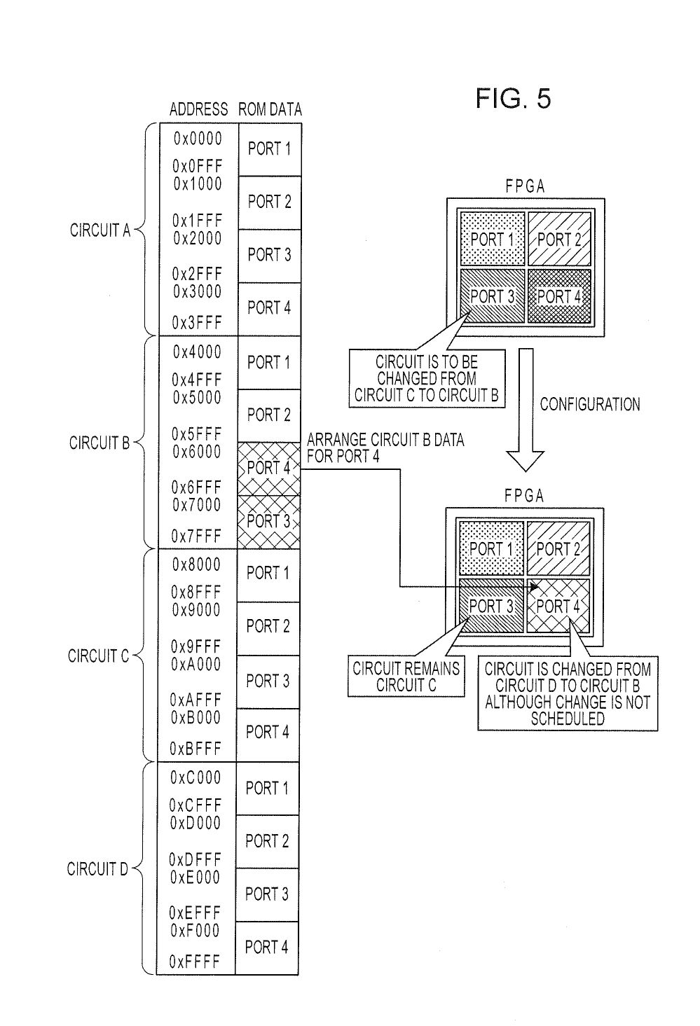

FIG. 5 illustrates exemplary arrangement of ROM data in the case where writing is performed in a wrong manner as illustrated in the right part of FIG. 4. As illustrated in FIG. 5, when a user wants to change the circuit in the port 3 from the circuit C to the circuit B, the user takes it for granted that the storage state of the ROM is correct, and specifies the addresses 0x6000 to 0x6FFF. As illustrated in the right part of FIG. 4, the circuit B data for the port 4 is stored at the addresses 0x6000 to 0x6FFF. Therefore, when configuration is performed by specifying an address, since each piece of circuit data for the configuration has unique location information, the circuit B data for the port 4 is arranged in the area of the port 4 in the FPGA in accordance with the unique location information included in the circuit B data for the port 4. That is, although the user does not intend to change the circuit in the port 4, that is, although a change for the port 4 is not scheduled, the circuit in the port 4 is changed from the circuit D to circuit B. On the other hand, although a user intends to change the circuit in the port 3 from the circuit C to the circuit B, that is, although a change for the port 3 is scheduled, the circuit in the port 3 continues to be the circuit C. Since a user takes it for granted that the storage state of the ROM is correct, when configuration is to be performed as illustrated in FIG. 5, the port 3 enters the non-operation state, whereas the port 4 remains in the operation state. Therefore, the port 4 is configured while the port 4 remains in the operation state. Thus, the circuit data in the port 4 is damaged, whereby the function which has been achieved in the port 4 is interrupted. For example, when a communication function, such as wavelength division multiplexing (WDM), a synchronous optical network (SONET), or Ethernet (registered trademark), is achieved in the circuit in the port 4, configuration causes an occurrence of a communication failure such as communication line cut, resulting in an adverse influence on network service.

The disclosed technology is devised in view of the issue described above, and is to provide a configuration controller, and a configuration control method, which avoid writing of wrong circuit data which a user does not intend into an FPGA.

An embodiment of a configuration controller and a configuration control method, which are disclosed in the present application, will be described in detail below with reference to the drawings. Note that the configuration controller and the configuration control method, which are disclosed in the present application, are not limited to the embodiment. In the embodiment, components having an identical function are designated with an identical reference numeral, and repeated description will be avoided.

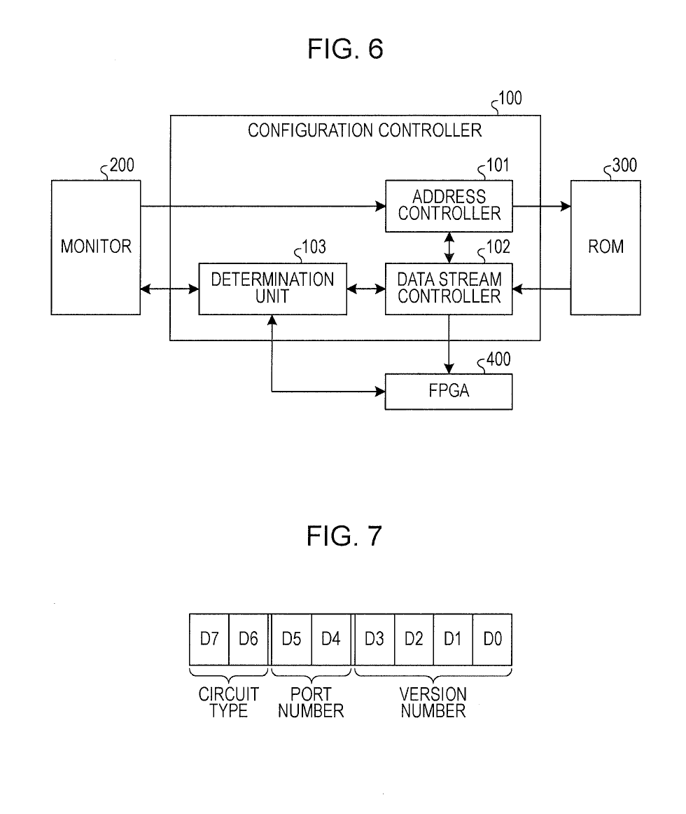

FIG. 6 is a block diagram illustrating an exemplary structure of a configuration controller according to one embodiment. In FIG. 6, a configuration controller 100 includes an address controller 101, a data stream controller 102, and a determination unit 103.

The configuration controller 100 is used while being connected to a monitor 200, a ROM 300, and an FPGA 400.

The FPGA 400 is a partially configurable FPGA. That is, the FPGA 400 includes FPGA areas obtained through division, each of the FPGA areas is called a port.

In the ROM 300, a user stores, in advance, multiple pieces of ROM data for combinations of a port and a circuit in such a manner that each piece of the ROM data is associated with an address of the ROM 300. For example, when the FPGA 400 includes four ports of the ports 1 to 4, as illustrated in FIG. 2 as described above, 16 pieces of ROM data, each of which is associated with an address of the ROM 300, are stored in the ROM 300.

The ROM data according to the present embodiment includes “ROM data management information” as illustrated in FIG. 7. That is, the ROM data according to the present embodiment includes the ROM data management information and the circuit data.

For example, as illustrated in FIG. 7, the ROM data management information includes a circuit type, a port number, and a version number. The data “circuit type” indicates the type of circuit data. The data “port number” indicates an arrangement target area for ROM data. The data “version number” indicates a version number for circuit data having the same type.

For example, in the example in FIG. 5 as described above, the circuit B data for the port 4 which is stored at the addresses 0x6000 to 0x6FFF includes ROM data management information having the circuit type “B”, the port number “4”, and the version number “XX”. The B circuit data for the port 3 which is stored at the addresses 0x7000 to 0x7FFF includes ROM data management information having the circuit type “B”, the port number “3”, and the version number “YY”. Assume that wrong information has been written into the ROM 300 as illustrated in the right part of FIG. 4 as described above. That is, the ROM data for the port 3 which is to be stored at the addresses 0x6000 to 0x6FFF is stored at the wrong addresses 0x7000 to 0x7FFF. The ROM data for the port 4 which is to be stored at the address 0x7000 to 0x7FFF is stored at the wrong addresses 0x6000 to 0x6FFF.

The ROM 300 is, for example, a rewritable memory such as a flash memory.

When a user configures each of the ports of the FPGA 400, the monitor 200 is used to issue an instruction to configure a desired port. A user uses the monitor 200 to specify a desired port and a desired circuit type whose data is to be arranged in the desired port, thereby issuing an instruction to perform configuration. A desired port is, for example, either one of the ports 1 to 4. A desired circuit type is, for example, either one of the circuits A to D.

The configuration controller 100, the ROM 300, and the FPGA 400 are disposed on the same substrate.

Upon reception of an instruction to perform configuration from a user, the monitor 200 outputs a configuration start request to the address controller 101. A configuration start request includes mode information indicating a combination of a desired port and a desired circuit type, and a configuration start trigger.

The monitor 200 stores ROM data management information for each of the pieces of ROM data stored in the ROM 300. Upon reception of an instruction to perform configuration from a user, the monitor 200 outputs ROM data management information corresponding to the combination of a desired port and a desired circuit type, to the determination unit 103.

For example, when a user specifies the port 3 as a desired port and the circuit B as a desired circuit type, the monitor 200 outputs ROM data management information including the circuit type “B”, the port number “3”, and the version number “YY”, to the determination unit 103.

The address controller 101 has a ROM data area map as illustrated in FIG. 2 as described above. The address controller 101 refers to the ROM data area map on the basis of the received mode information in response to the received configuration start trigger. The address controller 101 determines the start address of the specified ROM data which corresponds to the desired port and the desired circuit type, in the ROM data stored in the ROM 300.

For example, in the case where a desired port is the port 3 and where a desired circuit type is the circuit B, the address controller 101 determines the start address of the circuit B data for the port 3 to be “0x6000” in the ROM data area map illustrated in FIG. 2 as described above.

Then, the address controller 101 outputs a read signal and a specified address which serve as a readout request to the ROM 300, while incrementing, by one, the specified address whose initial value is the determined start address.

In addition, the address controller 101 outputs a “configuration stop signal” for controlling data output from the data stream controller 102 to the FPGA 400, to the data stream controller 102. The configuration stop signal is set to the enabled state in a normal state. Upon reception of a configuration start trigger from the monitor 200, the address controller 101 sets the configuration stop signal to the disabled state.

The ROM 300 outputs data corresponding to the specified address from the ROM data to the data stream controller 102 in accordance with the received readout request.

The data stream controller 102 controls data output to the FPGA 400 in accordance with the configuration stop signal received from the address controller 101. That is, when the configuration stop signal indicates “enabled”, the data stream controller 102 stops the output of the data received from the ROM 300 to the FPGA 400. When the configuration stop signal indicates “disabled”, the data stream controller 102 outputs the data received from the ROM 300, as a configuration data stream to the FPGA 400.

Upon completion of the output of the ROM data management information in the ROM data to the FPGA 400, the data stream controller 102 requests the address controller 101 to set the configuration stop signal to the enabled state and to stop the increment of the specified address temporarily. In accordance with this request, the address controller 101 sets the configuration stop signal to the enabled state and temporarily stops the increment of the specified address. The stop of the increment of the specified address causes the data output from the ROM 300 to the data stream controller 102 to be stopped. That is, upon completion of the output of the ROM data management information in the ROM data to the FPGA 400, before output of the circuit data to the FPGA 400, the data output from the data stream controller 102 to the FPGA 400 is temporarily stopped.

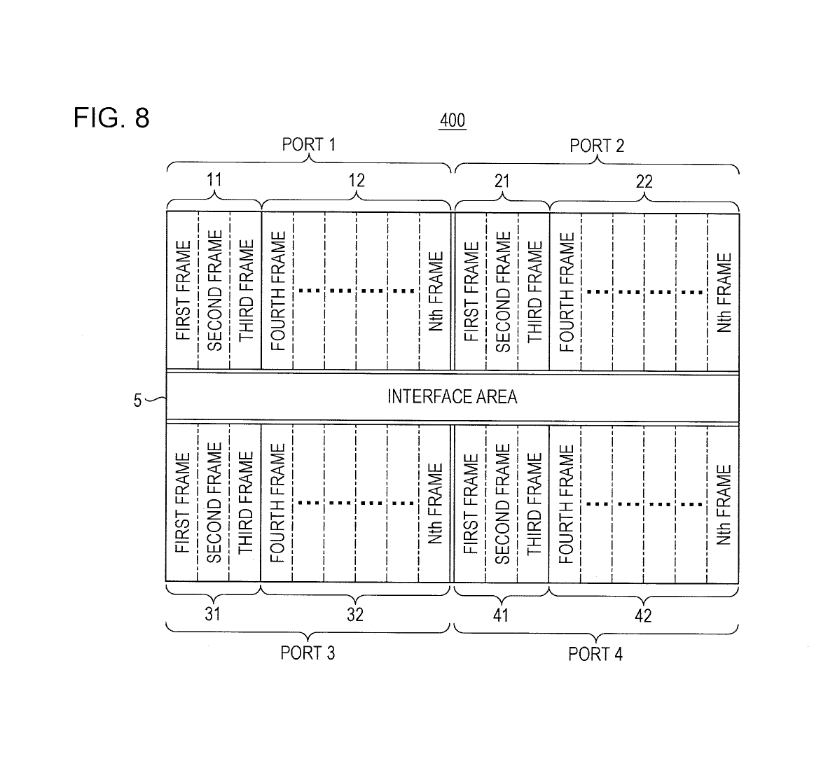

A frame structure of the ROM data will be described. FIG. 8 is a diagram illustrating exemplary area division in the FPGA 400 according to the embodiment.

In the present embodiment, as illustrated in FIG. 8, the area in the FPGA 400 is divided into four configuration target areas of the ports 1 to 4 and one configuration non-target area which is an interface area 5. Each of the configuration target areas of the ports 1 to 4 includes frames, the number of which is N. A frame is a minimum circuit unit on which partial configuration is performed. In the case where a large circuit is formed in each port, configuration is performed by coupling multiple frames, each of which is a minimum circuit unit.

In the present embodiment, a configuration target area is divided into a leading frame group and a remaining frame group. For example, N frames constituting the port 1 are separated into a leading frame group 11 constituted by the first to third frames, and a remaining frame group 12 constituted by the forth to Nth frames. Similarly, N frames constituting the port 2 are separated into a leading frame group 21 and a remaining frame group 22; N frames constituting the port 3, a leading frame group 31 and a remaining frame group 32; and N frames constituting the port 4, a leading frame group 41 and a remaining frame group 42.

In the leading frame groups 11, 21, 31, and 41, ROM data management information in ROM data is arranged. That is, in the leading frame group 11 of the port 1, ROM data management information having the port number “1” is arranged. Similarly, in the leading frame group 21 of the port 2, ROM data management information having the port number “2” is arranged. In the leading frame group 31 of the port 3, ROM data management information having the port number “3” is arranged. In the leading frame group 41 of the port 4, ROM data management information having the port number “4” is arranged. That is, in a leading frame group, ROM data management information which does not affect the operation of the FPGA 400 is arranged from the ROM data. In the remaining frame groups 12, 22, 32, and 42, circuit data which affects the operation of the FPGA 400 is arranged from the ROM data.

For example, in the case where a desired port is the port 3 and where a desired circuit type is the circuit B, as described above, the start address of the circuit B data for the port 3 is determined to be “0x6000”. As described above, the ROM data for the port 4 is stored at the addresses 0x6000 to 0x6FFF of the ROM 300 by mistake. Accordingly, in the leading frame group 41 among the leading frame groups 11, 21, 31, and 41, the ROM data management information including the circuit type “B”, the port number “4”, and the version number “XX” is arranged.

In the FPGA 400, each of the configuration target areas of the ports 1 to 4 is connected to the data stream controller 102 and the determination unit 103 via the interface area 5. In response to a request to read out the ROM data management information (hereinafter, referred to as a ROM-data-management-information readout request) which is transmitted from the determination unit 103, the ROM data management information is read out from either one of the leading frame groups 11, 21, 31, and 41, and is output to the determination unit 103 via the interface area 5.

Upon completion of output of the data for a leading frame group, that is, ROM data management information, as a configuration data stream to the FPGA 400, the data stream controller 102 outputs an information acquisition request to the determination unit 103. The data stream controller 102 notifies the determination unit 103 of an address in the FPGA 400 (hereinafter, may be referred to as a “ROM-data-management-information arrangement address”) that corresponds to the leading frame group in which the ROM data management information is arranged and that is included in the information acquisition request.

The determination unit 103 outputs a ROM-data-management-information readout request to the FPGA 400 in accordance with the received information acquisition request. The ROM-data-management-information readout request includes a ROM-data-management-information arrangement address transmitted from the data stream controller 102.

For example, as described above, in the case where ROM data management information including the circuit type “B”, the port number “4”, and the version number “XX” is arranged in the leading frame group 41, the ROM-data-management-information arrangement address is an address which corresponds to the leading frame group 41.

In accordance with the received ROM-data-management-information readout request, the FPGA 400 reads out the ROM data management information which is stored at the ROM-data-management-information arrangement address, and outputs the ROM data management information to the determination unit 103.

For example, as described above, in the case where the ROM-data-management-information arrangement address is an address which corresponds to the leading frame group 41, the ROM data management information including the circuit type “B”, the port number “4”, and the version number “XX” is output to the determination unit 103.

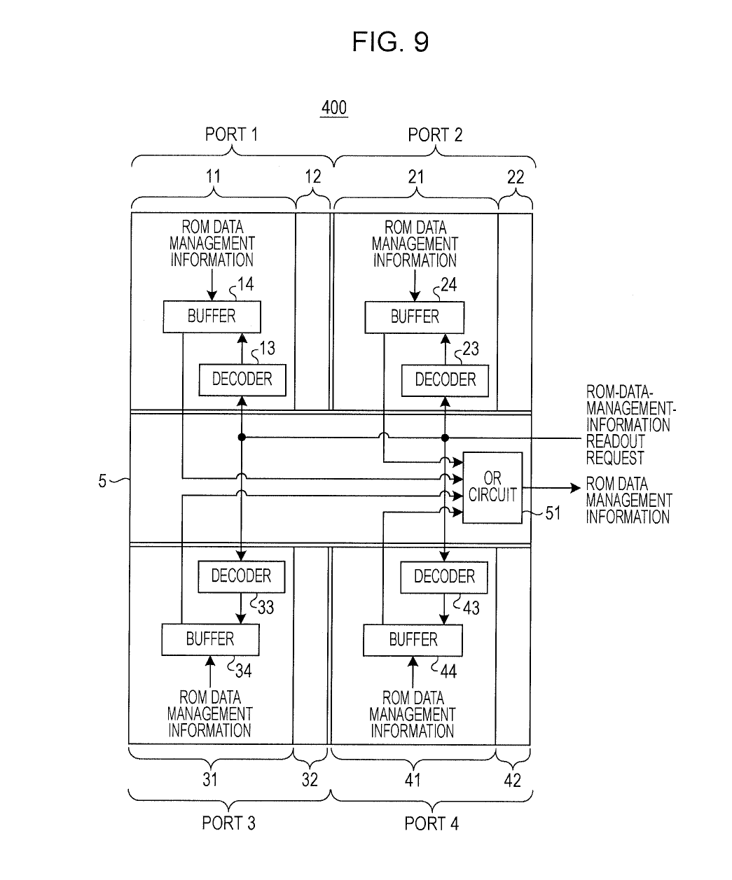

FIG. 9 is a functional block diagram illustrating an exemplary FPGA 400 according to the embodiment. FIG. 9 illustrates only functions which relate to the readout of the ROM data management information.

As illustrated in FIG. 9, each of the leading frame groups 11, 21, 31, and 41 of the ports 1 to 4 includes a readout circuit having a buffer and a decoder. An OR circuit 51 is formed in the interface area 5.

Decoders 13, 23, 33, and 43 decode the ROM-data-management-information arrangement address included in the ROM-data-management-information readout request so as to perform determination. That is, the decoder 13 determines whether or not the received ROM-data-management-information arrangement address is an address which corresponds to the leading frame group 11. Similarly, the decoder 23 determines whether or not the received ROM-data-management-information arrangement address is an address which corresponds to the leading frame group 21; the decoder 33, to the leading frame group 31; and the decoder 43, to the leading frame group 41.

For example, in the case where the received ROM-data-management-information arrangement address is an address which corresponds to the leading frame group 41, the decoder 43 outputs a readout request to a buffer 44.

Upon reception of a readout request from the decoders 13, 23, 33, and 43, buffers 14, 24, 34, and 44 read out corresponding ROM data management information from the leading frame group, and output the ROM data management information to the OR circuit 51.

For example, the buffer 44 which receives the readout request from the decoder 43 reads out the ROM data management information arranged in the leading frame group 41, that is, the ROM data management information including the circuit type “B”, the port number “4”, and the version number “XX”, from the leading frame group 41, and outputs the ROM data management information to the OR circuit 51.

The ROM data management information which is read out from either one of the buffers 14, 24, 34, and 44 is output from the FPGA 400 to the determination unit 103, via the OR circuit 51. Thus, upon completion of the arrangement of the ROM data management information in the leading frame group of the FPGA 400, the determination unit 103 obtains the arranged ROM data management information.

For example, in the case where the ROM-data-management-information arrangement address is an address which corresponds to the leading frame group 41, the determination unit 103 obtains the ROM data management information including the circuit type “B”, the port number “4”, and the version number “XX” from the FPGA 400.

The determination unit 103 performs correct-incorrect determination by comparing first ROM data management information received from the monitor 200 and second ROM data management information obtained from the FPGA 400. The determination unit 103 outputs the determination result to the data stream controller 102 and the monitor 200.

For example, in the above-described example, the first ROM data management information includes the circuit type “B”, the port number “3”, and the version number “YY”. The second ROM data management information includes the circuit type “B”, the port number “4”, and the version number “XX”.

Thus, when the first ROM data management information does not match the second ROM data management information, the determination unit 103 notifies the data stream controller 102 and the monitor 200 of the determination result indicating “incorrect”. When the first ROM data management information matches the second ROM data management information, the determination unit 103 notifies the data stream controller 102 and the monitor 200 of the determination result indicating “correct”.

That is, as illustrated in the right part of FIG. 4 as described above, when a user writes the circuit B data for the port 4 at the wrong addresses 0x6000 to 0x6FFF and writes the circuit B data for the port 3 at the wrong addresses 0x7000 to 0x7FFF, that is, when the ROM 300 stores data in a wrong manner, the determination result of the determination unit 103 indicates “incorrect”. As illustrated in the left part of FIG. 4 as described above, when a user writes the circuit B data for the port 3 at the addresses 0x6000 to 0x6FFF and writes the circuit B data for the port 4 at the addresses 0x7000 to 0x7FFF, that is, when the ROM 300 stores data in a correct manner, the determination result of the determination unit 103 indicates “correct”.

When the determination result indicates “correct”, the data stream controller 102 requests the address controller 101 to set the configuration stop signal to the disabled state again and to restart the increment of the specified address. In accordance with this request, the address controller 101 sets the configuration stop signal to the disabled state and restarts the increment of the specified address. Accordingly, when the determination result of the determination unit 103 indicates “correct”, the circuit data in the ROM data is read out from the ROM 300 subsequently to the ROM data management information, and is output as a configuration data stream via the data stream controller 102 to the FPGA 400. Therefore, when the determination result of the determination unit 103 indicates “correct”, the circuit data is arranged in the remaining frame group of the desired port, and the remaining frame group is configured. Thus, configuration is normally completed in the desired port.

When the determination result of the determination unit 103 indicates “incorrect”, the determination unit 103 notifies the data stream controller 102 and the monitor 200 of the determination result indicating “incorrect”, and aborts the configuration process.

When the monitor 200 is notified of the determination result indicating “incorrect”, a user recognizes that the ROM data for a different port was written by mistake at the addresses at which the user wants to store the ROM data for a desired port, when the ROM data was stored into the ROM 300. Therefore, the user checks the state in which the ROM data is stored in the ROM 300, and modifies the storage state of the ROM data so that the correspondences between the ROM data for each of the ports and an address in the ROM 300 match what the user intends.

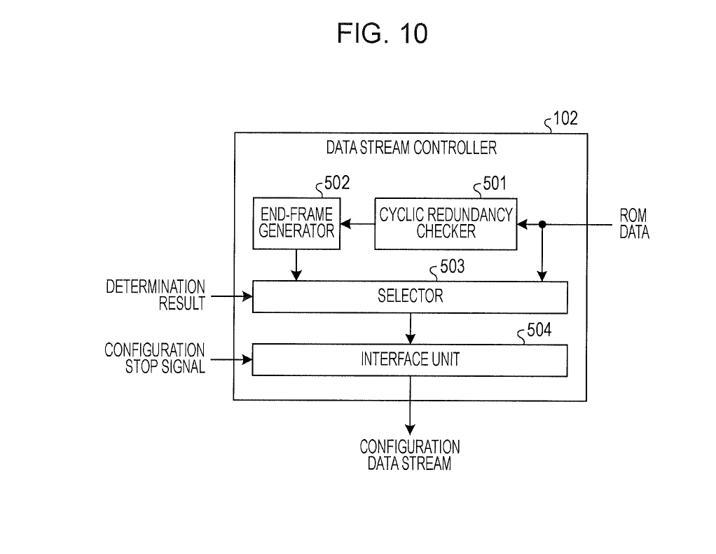

FIG. 10 is a block diagram illustrating an exemplary structure of the data stream controller according to the embodiment. In FIG. 10, the data stream controller 102 includes a cyclic redundancy checker 501, an end-frame generator 502, a selector 503, and an interface unit 504.

The cyclic redundancy checker 501 and the selector 503 receive ROM data from the ROM 300.

The cyclic redundancy checker 501 performs a CRC computation on the data for the leading frame group which is included in the ROM data, that is, the ROM data management information, and outputs a CRC value to the end-frame generator 502.

The end-frame generator 502 generates end frame data including the CRC value, and outputs the generated end frame data to the selector 503.

The selector 503 outputs the data for the leading frame group which is included in the ROM data to the interface unit 504. For the data for the remaining frame group which is included in the ROM data, that is, the circuit data, the selector 503 selects the data for the remaining frame group or the end frame data in accordance with the determination result of the determination unit 103, and outputs the selected data to the interface unit 504. That is, when the determination result of the determination unit 103 indicates “correct”, the selector 503 selects the data for the remaining frame group, and outputs the selected data to the interface unit 504. When the determination result of the determination unit 103 indicates “incorrect”, the selector 503 selects the end frame data and outputs the selected data to the interface unit 504.

When the configuration stop signal received from the address controller 101 is in the disabled state, the interface unit 504 outputs the data selected by the selector 503, as a configuration data stream to the FPGA 400.

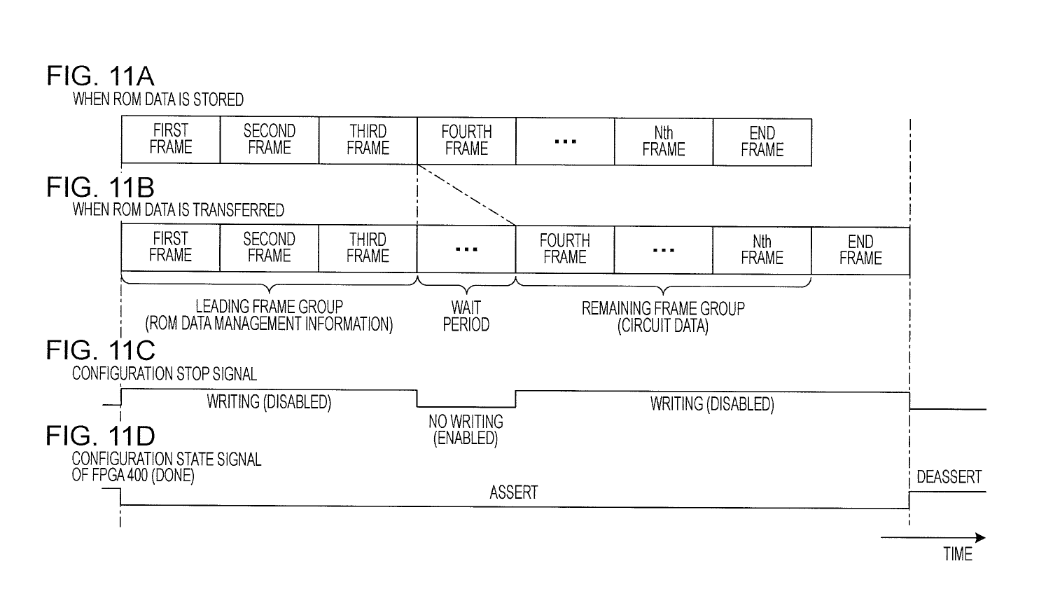

FIGS. 11A to 11D are a diagram for describing an operation of the configuration controller according to the embodiment. FIGS. 11A to 11D illustrate the case in which ROM data is constituted by frames, the number of which is N. FIG. 11A illustrates the state of frames at the time when ROM data is stored in the ROM 300. FIG. 11B illustrates the state of frames at the time when the ROM data is transferred from the ROM 300 to the data stream controller 102. FIG. 11C illustrates the state of the configuration stop signal. FIG. 11D illustrates the state of a configuration state signal of the FPGA 400.

As illustrated in FIG. 11A, ROM data includes an end frame attached to frames. The first to third frames constitute a leading frame group, and the fourth to Nth frames constitute a remaining frame group. The leading frame group includes the ROM data management information in the ROM data. The remaining frame group includes the circuit data in the ROM data.

As illustrated in FIG. 11C, the configuration stop signal is in the disabled state while the leading frame group is processed. Thus, the leading frame group is written and arranged into the FPGA 400. That is, in the first stage of configuration, the ROM data management information is arranged in the first to third frames (leading frame group) in the FPGA 400.

After the configuration using the ROM data management information is performed, the configuration stop signal is changed from the disabled state to the enabled state. Accordingly, upon completion of the arrangement of the ROM data management information in the leading frame group in the FPGA 400, the transfer of the ROM data from the ROM 300 to the data stream controller 102 stops, causing the writing of the ROM data into the FPGA 400 to be stopped. That is, at the time point of completion of the first stage of configuration, the circuit data has not yet been written into the FPGA 400.

Note that, as soon as frames are written into the FPGA 400, a circuit is formed in the FPGA 400 by using the frames one by one without waiting for an end frame. Thus, before the completion of configuration (DONE), it is possible for the FPGA 400 to operate the circuit at the time point when ROM data for some frames among the first to Nth frames is written. Therefore, even before configuration using the circuit data, it is possible to read out the ROM data management information from the FPGA 400 upon completion of the configuration using the ROM data management information.

While the writing of ROM data into the FPGA 400 is stopped, that is, during a WAIT period, the determination unit 103 performs the series of correct-incorrect determination processes described above on the ROM data management information. That is, in a WAIT period, the determination unit 103 outputs a ROM-data-management-information readout request to the FPGA 400 in accordance with the received information acquisition request. The FPGA 400 reads out second ROM data management information which is stored at the ROM-data-management-information arrangement address in accordance with the received ROM-data-management-information readout request, and outputs the second ROM data management information to the determination unit 103. The determination unit 103 compares first ROM data management information received from the monitor 200 with the second ROM data management information obtained from the FPGA 400, and performs the correct-incorrect determination. The determination unit 103 outputs the determination result to the data stream controller 102 and the monitor 200.

When the determination result of the determination unit 103 indicates “correct”, the configuration stop signal is changed from the enabled state to the disabled state. Thus, when the determination result indicates “correct”, the WAIT period ends, and the transfer of the ROM data from the ROM 300 to the data stream controller 102 is restarted. This also restarts the writing of the ROM data into the FPGA 400. That is, the circuit data is arranged in the fourth to Nth frames (remaining frame group) in the FPGA 400, which is performed as the second stage of configuration. The end frame stored in the ROM 300 is output via the data stream controller 102 to the FPGA 400. Thus, in the case where the determination result indicates “correct”, upon completion of the second stage of configuration, that is, upon completion of arrangement of the circuit data in the remaining frame group in the FPGA 400, configuration is normally completed.

When the determination result of the determination unit 103 indicates “incorrect”, the configuration stop signal is maintained at the enabled state. The end frame generated in the end-frame generator 502 is output to the FPGA 400. Thus, in the case where the determination result indicates “incorrect”, upon completion of the first stage of configuration, that is, upon completion of the arrangement of the ROM data management information in the leading frame group in the FPGA 400, the configuration process is aborted.

Upon reception of an end frame, the FPGA 400 completes the configuration. When the configuration state starts, the FPGA 400 asserts the configuration state signal (DONE). When the configuration is completed, the FPGA 400 de-asserts the configuration state signal. Reception of an end frame by the FPGA 400 causes the configuration to be completed. When the determination result of the determination unit 103 indicates “incorrect”, the end frame stored in the ROM 300 is not input to the FPGA 400. Accordingly, when the determination result indicates “incorrect”, the end-frame generator 502 generates an end frame.

The various processes described in the above-described embodiment may be achieved by causing a central processing unit (CPU), which is not illustrated, to execute programs prepared in advance. That is, programs corresponding to processes executed by at least one of the address controller 101, the data stream controller 102, the determination unit 103, the cyclic redundancy checker 501, the end-frame generator 502, the selector 503, and the interface unit 504 may be stored in a memory in advance, and each of the programs may be read out to a CPU to function as a process. Each program does not have to be stored in a memory in advance. That is, for example, each program may be recorded in advance on a portable recording medium, such as a flexible disk (FD), a compact disk-read-only memory (CD-ROM), a magneto-optical (MO) disk, a digital versatile disk (DVD), an integrated circuit (IC) card, or a memory card, which is connectable to the CPU, and may be read out to the CPU to function as a process. In addition, for example, each program may be stored in advance in, for example, a computer or a server which is connected to the CPU in a wired or wireless manner via networks, such as the Internet, a local-area network (LAN), and a wide area network (WAN), and may be read out to the CPU to function as a process.

As described above, according to the above-described embodiment, in the configuration controller 100 which controls configuration of the partially configurable FPGA 400, the determination unit 103 determines whether or not circuit data to be arranged in either one of multiple ports in the FPGA 400 matches desired circuit data for which a desired arrangement target port is specified, before circuit data to be arranged is written into the FPGA 400. The data stream controller 102 controls whether or not circuit data to be arranged is to be written into the FPGA 400, in accordance with the determination result of the determination unit 103. Thus, writing of wrong circuit data different from circuit data desired by a user, that is, wrong circuit data which a user does not intend to write, into the FPGA 400 is avoided.

According to the above-described embodiment, the determination unit 103 compares the port number indicating the arrangement target area for circuit data to be arranged, with the port number indicating the arrangement target area for desired circuit data, thereby determining whether or not the circuit data to be arranged matches the desired circuit data. Thus, change of the circuit data in a port whose circuit is not to be changed is avoided.

According to the above-described embodiment, each of the areas in the FPGA 400 includes a leading frame group and a remaining frame group subsequent to the leading frame group. After the first write process in which the data stream controller 102 writes the arrangement target port number into a leading frame group, before the second write process in which the data stream controller 102 writes circuit data to be arranged into a remaining frame group, the determination unit 103 obtains the arrangement target port number from the leading frame group. Thus, upon completion of the first write process which does not affect the operation of the FPGA 400, determination whether or not circuit data is correct may be performed. In other words, before the second write process which affects the operation of the FPGA 400, determination whether or not circuit data is correct may be performed.

According to the above-described embodiment, when circuit data to be arranged is determined to match desired circuit data, the data stream controller 102 performs the second write process after the first write process. When circuit data to be arranged is determined to be circuit data that does not match desired circuit data, the data stream controller 102 does not perform the second write process which is to be performed after the first write process. Thus, even when wrong circuit data which affects the operation of the FPGA 400 is read out from the ROM 300, writing of the wrong circuit data into the FPGA 400 is avoided. In addition, when circuit data to be arranged matches circuit data which a user intends to arrange, the desired port is configured by using the circuit data.

In the above-described embodiment, an FPGA taken as an exemplary programmable device is described. However, the disclosed technology may be implemented by using a programmable device other than an FPGA in a manner similar to that described above.

In the above-described embodiment, the description is made in which ROM data management information includes a circuit type, a port number, and a version number (see FIG. 7). However, in configuration, when a user regards determination whether or not a version number is correct as unnecessary, a version number may be removed from the ROM data management information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A configuration controller configured to control configuration of a partially configurable programmable device, the configuration controller comprising:
a determination unit configured to determine whether or not circuit data to be arranged in any one of a plurality of areas in the programmable device matches desired circuit data for which a desired arrangement target area is specified, before the circuit data to be arranged is written into the programmable device; and
a data controller configured to control whether or not the circuit data to be arranged is to be written into the programmable device, in accordance with the determination result of the determination unit.

2. The configuration controller according to claim 1,
wherein the determination unit determines whether or not the circuit data to be arranged matches the desired circuit data, by comparing first information indicating an arrangement target area for the circuit data to be arranged with second information indicating the arrangement target area for the desired circuit data.

3. The configuration controller according to claim 2,
wherein each of the plurality of areas includes a first frame group and a second frame group that is subsequent to the first frame group, and
wherein the determination unit obtains the first information from the first frame group, after the data controller performs a first write process of writing the first information into the first frame group, before the data controller performs a second write process of writing the circuit data to be arranged into the second frame group.

4. The configuration controller according to claim 3,
wherein, when the circuit data to be arranged is determined to match the desired circuit data, the data controller performs the second write process after the first write process, and
wherein, when the circuit data to be arranged is determined to be circuit data that does not match the desired circuit data, the data controller does not perform the second write process which is to be performed after the first write process.

5. A configuration control method of a partially configurable programmable device, the configuration control method comprising:
determining whether or not circuit data to be arranged in any one of a plurality of areas in the programmable device matches desired circuit data for which a desired arrangement target area is specified, before the circuit data to be arranged is written into the programmable device; and
controlling whether or not the circuit data to be arranged is to be written into the programmable device, in accordance with the determination result, executed by a processor.

6. A computer-readable recording medium storing a program for causing a computer to execute a procedure for controlling configuration of a partially configurable programmable device, the procedure comprising:
determining whether or not circuit data to be arranged in any one of a plurality of areas in the programmable device matches desired circuit data for which a desired arrangement target area is specified, before the circuit data to be arranged is written into the programmable device; and
controlling whether or not the circuit data to be arranged is to be written into the programmable device, in accordance with the determination result.
